(19) United States
(12) Patent Application Publication
(10) Pub. No.: US 2015/0011206 A1
(43) Pub. Date: Jan. 8, 2015

(54) DEVICE FOR MONITORING A DISTRIBUTION POINT

(71) Applicant: Reichle & De-Massari AG, Wetzikon (CH)

(72) Inventors: Thomas Wellinger, Baeretswil (CH); Markus Peter Huber, Gruet (CH)

(73) Assignee: Reichle & De-Massari AG, Wetzikon (CH)

(21) Appl. No.: 14/376,995

(22) PCT Filed: Feb. 8, 2013
(86) PCT No.: PCT/EP2013/052580

§ 371 Date: Aug. 6, 2014

(30) Foreign Application Priority Data
Feb. 9, 2012 (CH) 00175/12

(51) Int. Cl. H04W 24/04

(52) U.S. Cl. CPC H04W 24/04
USPC 455/423

(57) ABSTRACT

A device for monitoring a distribution point in telecommunication networks, comprises a control unit, a battery, a communications unit, and at least one sensor. The communications unit is enabled to dispatch and receive symbol sequences via a mobile phoning network. The control unit and the communications unit are programmed to be, in a normal state, in a sleep mode. The control unit is further programmed to autonomously initiate, for an event detected by the at least one sensor, an alert of the communications unit, wherein the communications unit then proactively dispatches an alarm message via the mobile phoning network. The device is further programmed so that the communications unit is alerted at predetermined times, dispatches a status report and remains active for a predetermined time period to the purpose of receiving a programming message transmitted to the device via the mobile phoning network.

The invention relates to the field of distribution points of telecommunication lines, e.g. of cable sleeves, distribution boxes, house transfer points, centers, etc. It relates in particular a device for monitoring a distribution point in view of external conditions which make an undisturbed operation impossible.

It is known to use so-called cable sleeves at branching points of optic fibers and copper cables in telecommunication networks. In such a cable sleeve several optic fiber cables and/or copper cables are brought together. Cable sleeves of this type are often placed in subterranean ducts. However, changing environmental conditions in such ducts are only not easily noticed by the operator. In particular, a too high degree of air moisture or water ingress can damage the connections within the cable sleeve in the long run and may cause network breakdown. Furthermore, cable sleeves are also placed above ground, e.g. in street distribution boxes, where in particular vandalism and/or theft may result in damages to the cable sleeve and hence to network breakdown. In the same way, however, may cable sleeves placed in ducts be subject to vandalism and/or theft. To ensure an undisturbed operation, cable sleeves therefore have to be checked on a regular basis, which results in considerable costs.

From prior art it is already known to monitor cable sleeves by measuring the optical damping by means of optical interference filters or by means of mechanical sensors. This type of telemonitoring, however, delegates monitoring to the network provider, who is not always identical to the party making the infrastructure available. Moreover, with this kind of monitoring, a damage is often only detected when the optical fiber connections are already damaged, which is often too late.

It is hence an objective of the invention to provide, for monitoring a telecommunication network distribution point, a device which overcomes disadvantages of the prior art approaches and which, in particular, is able to reliably and promptly detect when the conditions change in such a way that damages to the fiber-optical or other communication line connections or generally at the distribution point are to be feared.

A first device according to the invention, provided for monitoring a distribution point—in particular a cable sleeve in a sleeve duct with a duct cover—is proposed. The device comprises a control unit, a battery as an energy supply unit (or a battery compartment or another battery connection for a battery present in the device) and a communications unit as well as at least one sensor, which is implemented as an acceleration sensor, motion sensor and/or orientation sensor, wherein the at least one sensor is in a connection with the control unit and is, via said control unit, actuatable, readable and suppliable with electrical energy. Such types of sensors are basically known and are widely in use, e.g. in “smartphones”. In a device according to the invention they can be applied to detect commotions or such like; they can also trigger an alarm in the case of theft or vandalism.

The first device according to the invention is provided to be operated self-sufficiently and without any energy generating means, i.e. neither does it require an energy supply via solar cells or the like nor is it connected to a power grid. The control unit and the communications unit are programmed to be, in a normal state, in a sleep mode, wherein the control unit is further programmed to autonomously initiate, in the case of an event detected by the at least one sensor, an alert of the communications unit, The communications unit is enabled to dispatch and receive symbol sequences—e.g. text messages via “SMS” or comparable telecommunication services—via a mobile phoning network. The communications unit is further programmed to proactively dispatch, in the case of an alarm—i.e. of an event that has been measured by the at least one sensor and does not comply with the standard—an alarm message via the mobile phoning network. The device is further programmed in such a way that the communications unit is alerted at predetermined times, dispatches a status report and remains active for a predetermined time period to the purpose of receiving a programming message that has possibly been transmitted to the device via the mobile phoning network, and the communications unit and/or the control unit are/is provided to be re-programmed by such a programming message. Preferably the first device according to the invention comprises a clock which is in particular provided to supply the control unit and/or the communications unit with at least one time information.

Furthermore, a second device according to the invention for monitoring a distribution point—in particular a cable sleeve in a sleeve duct with a duct cover—is provided. The device comprises a control unit, a battery as an energy supply unit (or a battery compartment or another battery connection for a battery present in the device), a clock and a communications unit as well as at least one sensor for measuring moisture and/or for detecting a water ingress, wherein the at least one sensor is in a connection with the control unit and is, via said control unit, actuatable, readable and suppliable with electrical energy. In particular, a first sensor for measuring moisture as well as a second sensor for detecting a water ingress can be present, each of which being connected to the control unit.

The second device according to the invention is provided to be operated self-sufficiently and without any energy generating means, i.e. neither does it require an energy supply via solar cells or the like nor is it connected to a power grid. The control unit and the communications unit are programmed to be, in a normal state, in a sleep mode, wherein the control unit is further programmed to autonomously initiate, in the case of an event detected by the sensor or one of the sensors, an alert of the communications unit. The communications unit is enabled to dispatch and receive symbol sequences—e.g. text messages via “SMS” or comparable telecommunication services—via a mobile phoning network. The communications unit is further programmed to proactively dispatch, in the case of an alarm—i.e. of an event that has been measured by the sensor or one of the sensors and does not comply with the standard—an alarm message via the mobile phoning network. The device is further programmed in such a way that the communications unit is alerted at predetermined times, dispatches a status report and remains active for a predetermined time period to the purpose of receiving a programming message that has possibly been transmitted to the device via the mobile phoning network, and the communications unit and/or the control unit are/is provided to be re-programmed by such a programming message.

Herein the previously mentioned units of the first and the second devices according to the invention are to be understood in a view to function; they do not necessarily have to be embodied physically separate/separable. On the contrary, the units can be entirely or partially integrated with each other—e.g. sharing an integrated circuit (e.g. in a single “chip”)—and their functions can be implemented by identical physical entities or groups of entities.

For example, the respective clock of the first and the second devices according to the invention can be embodied as the clock of an integrated circuit in which the control unit and/or the communications unit are/is implemented.

The period between two status reports can be relatively long. For example, the sequence “alerting the communications unit—status report—remaining ready-to-receive” can occur periodically with a period length of between one day and two months, in particular of between 1 and 3 weeks. The period or generally the predetermined times can be programmable (by a programming message of the previously mentioned type).

The time period during which the respective communications unit of the first and the second devices according to the invention remains active—i.e. ready-to-receive—depends on the specifications of the provider of the mobile phoning network and may amount to, e.g., between half a minute and five minutes. As an option, this time period may be programmable as well.

Actually, battery-operated sensor devices for monitoring ducts are already known from the prior art, e.g. from US patent documents U.S. Pat. No. 7,002,481, U.S. Pat. No. 7,598,858 und U.S. Pat. No. 7,221,282. However, these devices are not suitable for monitoring cable sleeves, firstly because they do not have the lifespan required for low-maintenance operation. In particular, for being suitable as a device for monitoring a cable sleeve, they would have to be reliably operable even if arranged below a metallic duct cover (and not, e.g., requiring a separate non-conductive duct cover), the communication module having to send at a huge dispatch power accordingly. Secondly, these devices would not be suitable for monitoring cable sleeves as cable sleeves underlie increased requirements regarding reliability and it would, for example, not be tolerable if breakdown of the device was not detected for a substantial period. Thirdly, with cable sleeves, it has to be expected that operation parameters and/or responsibilities change over time, and the devices according to the prior art do not have the flexibility therefor required.

In contrast, the first as well as the second devices according to the invention provide a plurality of relevant advantages:
Flexibility in application: As the first and the second devices according to the invention are self-sulficient, they can be built in or, for example, mounted to any type of cable sleeves or other distribution points—even after assembly—independently from the location of the cable sleeves, of an energy supply being present, etc.
Lifespan: the procedure according to the invention allows a lifespan of several years, even with a high level of dispatch power of the communication module and using a commercially obtainable battery.
Reliability: Thanks to the procedure according to the invention, a possible breakdown of the first and the second device according to the invention would be promptly detected.
Programmability: Despite the long battery lifespan achieved, the first and the second devices according to the invention continue to be programmable. This results from the feature that the communications unit remains active for a predetermined time following the status report. This is in particular advantageous in combination with using a text-based telecommunication service, as symbol sequences are “parked” for a certain time by such a type of telecommunication service. The provider can therefore set up a programming instruction previously to the status report expected and this is reliably received even if the clock of the device does not run in a strictly exact manner. This, in its turn, allows using low-cost, energy-saving clocks in the device, strict synchronicity between the first and the second devices according to the invention and the monitoring point not being a requirement.

In exemplary embodiments at least the control unit, the communications unit and the battery as well as in most cases the clock are arranged in a housing, for example a hermetic housing. The sensor or the sensors are connected to the control unit by way of a wire connection, which wires are guided out of the housing, e.g., by feed-throughs. As a result of this, the operational capability is ensured even in the case of a sudden massive water ingress. It is also possible to arrange, for example, a moisture sensor and/or an acceleration sensor, motion sensor and/or orientation sensor directly in the housing, which is then not necessarily hermetic, e.g. directly on a printed circuit board that also carries the processor means forming the control unit and/or the communications unit.

The water sensor and/or the acceleration sensor, motion sensor and/or orientation sensor can work on the basis of a resistance measurement as is generally known. Such sensors can continuously operate consuming virtually no energy. Accordingly, the control unit is then, for example, provided to operate the water sensor even if the control unit itself is in the sleep mode. In this case, an alert is initiated if the water sensor is in the water and/or the acceleration sensor, motion sensor and/or orientation sensor detects a corresponding event.

The moisture sensor can, for example, be queried periodically. To this purpose, for example, the control unit, which is supplied with a time information by the clock, is periodically alerted to such a degree that it can query the moisture sensor. As this procedure consumes a comparably low quantity of electrical energy. the rate of querying the moisture sensor may be chosen to be rather high, e.g. once or several times per hour. In exemplary embodiments of the invention the moisture sensor is read out at least 6 times per day, at least 24 times per day or even at least 48 times per day. It is also possible that, after a first moisture threshold value which is below the alarm value has been exceeded, reading out at an increased rate is provided.

Besides the at least one sensor, the first and the second devices according to the invention may comprise a respective further sensor. In particular, the one further sensor can be embodied as an acceleration sensor, motion sensor and/or orientation sensor,

The communications unit will generally comprise an antenna. This antenna can—if applicable—be connected, inside the housing or outside the housing but continuously, to the processor means of the communications unit—i.e., for example, to the integrated circuit that also forms the control unit—by means of a conductive connection. As an alternative, said antenna can also be arranged outside the cable sleeve or other distribution point or even outside the duct. It may, for example, be coupled to the processor means via a capacitive connection without the mechanical protection of the cable sleeve or other distribution point being negatively affected.

The antenna can be embodied as an omnidirectional antenna. As an alternative, it is also possible to provide the antenna with a directional beam characteristic. Combinations are also conceivable.

The communications unit and/or the control unit are programmable. For example, the address for symbol sequences (messages) dispatched by the device may be programmable. Such an address may be a phone number which a text message (more exactly: symbol sequence message) is sent to, or possibly an email address, or other address. As an alternative or additionally, threshold values, other alarm criteria, alarm signals, alert frequencies, alert times, a period length for the communications unit remaining active following dispatch of the status report, and/or other parameters may be programmable.

In the following, exemplary embodiments of the invention are described in detail on the basis of drawings. The drawings show

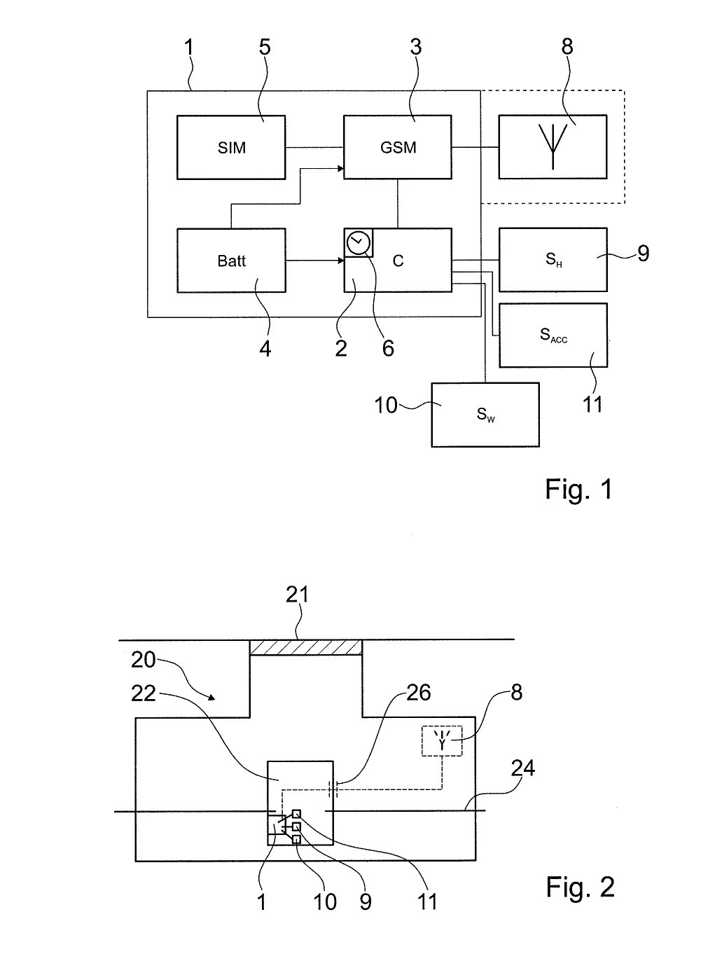

in FIG. 1 a schematic view of a device according to the invention, and

in FIG. 2 a duct with a cable sleeve.

The device comprises a housing 1, which is, for example, hermetically sealed, and comprises in the interior of the housing a control unit 2 and a communications unit 3 as well as a battery 4. The control unit 2 and the communications unit 3 can be implemented by an integrated circuit each or by sharing an integrated circuit. The battery supplies the control unit 2 and the communications unit 3 with the electrical power required. The communications unit (3) is herein embodied as a GSM module which is in connection with a SIM card 5 and obtains the necessary identity data in the telecommunication network from said SIM card 5 in a customary manner. Other solutions (including telecommunication standards other than GSM, e.g. UMTS, etc.) are also conceivable. The device further comprises a clock 6. In the exemplary embodiment shown the clock is integrated in the control unit. Differing from this, the clock can also be implemented as a separate element in the communications unit (if the communications unit is implemented separate from the control unit) or in the integrated circuit that forms both the communications unit and the control unit or as part of another element. Using several clocks is also conceivable, for example in the case of separate integrated circuits provided for the control unit and the communications unit.

In the exemplary embodiment shown a separate antenna 8 is assigned to the communications unit. Said antenna 8 can be connected to the communications unit by means of an electrically conductive connection. It can be arranged outside the housing and/or—as indicated by the dotted line—inside the housing. Integrated solutions, in which the antenna is implemented by the integrated circuit of the communications unit itself, are also conceivable.

The control unit 2 actuates a moisture sensor 9 and a water sensor 10. Both sensors are, for example, present outside the housing 1, while inside the cable sleeve or other distribution point. However, it is also possible that in particular the moisture sensor is present in the housing itself, wherein the housing may not necessarily be hermetically sealed according to conditions. As indicated in FIG. 1, the water sensor 10 is preferentially arranged below the housing and as far down inside the cable sleeve as possible, in order to detect a water ingress early on.

An optional acceleration sensor 11, which is also actuated by the control unit, is also outlined in FIG. 1.

The device according to FIG. 1 is, for example, operated as follows: In a normal state, the control unit 2 and the communications unit 3 are in a sleep mode, in which the clock 6 and the water sensor 10 are switched on (which means for the water level sensor that it is supplied with a voltage, virtually no power being consumed in the normal state). The control unit, respectively the part of the control unit required for actuating and reading out the moisture sensor, is alerted periodically, e.g. every 15 minutes, to the purpose of reading out the moisture sensor.

The control unit is provided to evaluate the measurement values of the moisture sensor and the water sensor at least to such a degree that an alarm can be triggered when a certain criterion is fulfilled. On occurrence of said criterion (water detected) in the water sensor, the control unit 2 is alerted and alerts in its turn the communications unit 3 to dispatch an alarm signal. If the value read out from the moisture sensor fulfills the criterion (e.g. exceeding a threshold value which may be optionally programmable), the control unit 2 remains in the alerted state and alerts the communications unit 3 to dispatch an alarm signal. If the value read out from the moisture sensor does not fulfill the criterion, this returns into the sleep mode.

The alarm signal dispatched by the communications unit 3 if applicable can be a text message (SMS) which may optionally comprise information on the alarm, e.g. “water ingress” or “moisture above the threshold value” or similar information. Transmitting concrete measurement values as well as information on the sender—e.g. an identification of the cable sleeve (or other distribution point as the case may be)—and/or further information, e.g. the instant when the irregularity was detected, etc. is also possible.

The communications unit is also alerted, for example periodically—normally with a greater period—to dispatch a status report, This may be accompanied by an alert of the control unit and may—depending on the implementation of the control unit and the communications unit and of their connection—be effected by the control unit. Following the alert, the communications unit dispatches a status report. Said status report can also be implemented as a text message and may contain, for example, the identification of the cable sleeve or other distribution point, optionally moreover the measurement values in particular. of the moisture sensor.

Subsequently the communications unit remains ready-to-receive during a certain time period. The time period is chosen such that it is sufficient for receiving a message that has previously been dispatched from a monitoring point and has then been parked with the provider of the mobile phoning network during inactivity of the communications unit. Such a message may, in particular, be a programming message. Accordingly the monitoring point is operated in such a way that the message is dispatched within a certain time period previously to the instant—known to the monitoring point—of alerting the communications unit, e.g. maximally 24 hours previously.

Programming may concern the control unit and/or the communications unit. It is preferably implemented directly after receiving a programming message. Following the time period in which the communications unit is ready-to-receive, or if applicable following programming, the communications unit and, as the case may be the control unit, can return to the sleep mode.

In case there is additionally the optional acceleration sensor 11 or another sensor, it can be operated under conditions analogous to the moisture sensor and/or the water sensor, wherein it may, for example, in the first case be read out simultaneously with the moisture sensor. Such optional additional sensors can, depending on programming, also initiate an alarm or may only serve for information purposes wherein the measurement results are merely transmitted together with the status reports.

FIG. 2 shows, in a very schematic view, a duct 20 with a partially metallic duct cover 21, in which a cable sleeve 22 is located which connects data lines 24 that are implemented as optic fibres and/or copper cables and are fed into and out of the duct 20. In the interior of the cable sleeve 22 there is a device according to the invention, of which the housing as well as the sensors 9, 10 for water and moisture are shown in FIG. 2.

In the figure there is also the—optional—solution depicted of an antenna which is external to the cable sleeve 22 (dashed line). Said antenna is provided for the case that the communication module, e.g. due to its positioning with respect to duct cover and mobile antenna, does not have sufficient dispatch power. A line leading to the antenna 8 is capacitively coupled to the antenna which is external to the sleeve, which is symbolized in FIG. 2 by a capacitive coupler 26.

1. A device for monitoring a telecommunication line distribution point, comprising:
a control unit,
a battery as an energy supply unit or a connection for a 5 battery as an energy supply unit,
a communications unit,
at least one sensor, which is implemented as an acceleration sensor, motion sensor and/or orientation sensor,
wherein the at least one sensor is in a connection with the control unit and is, via said control unit, actuatable, readable and suppliable with electrical energy,
wherein the device is provided to be operated self-sufficiently and without any energy generating means,
wherein the control unit and the communications unit are programmed to be, in a normal state, in a sleep mode,
wherein the communications unit is enabled to dispatch and receive symbol sequences via a mobile phoning network,
wherein the control unit is further programmed to autonomously initiate, in the case of an event detected by the at least one sensor, an alert of the communications unit, and the communications unit is enabled to then proactively dispatch an alarm message via the mobile phoning network,
wherein the device is further programmed in such a way that the communications unit is alerted at predetermined times, dispatches a status report and remains active for a predetermined time period to the purpose of receiving a programming message that has possibly been transmitted to the device via the mobile phoning network, and
wherein the communications unit and/or the control unit are/is provided to be re-programmed by such a programming message.

2. A device for monitoring a telecommunication line distribution point, comprising:
a control unit,
a battery as an energy supply unit or a connection for a battery as an energy supply unit,
a clock,
a communications unit,
at least one sensor, for measuring moisture and/or for detecting a water ingress,
wherein the at least one sensor is in a connection with the control unit and is, via said control unit, actuatable, readable and suppliable with electrical energy,
wherein the device is provided to be operated self-sufficiently and without any energy generating means,
wherein the control unit and the communications unit are programmed to be, in a normal state, in a sleep mode,
wherein the communications unit is enabled to dispatch and receive symbol sequences via a mobile phoning network,
wherein the control unit is further programmed to autonomously initiate, in the case of an event detected by the at least one sensor, an alert of the communications unit, and the communications unit is enabled to then proactively dispatch an alarm message via the mobile phoning network,
wherein the device is further programmed in such a way that the communications unit is alerted at predetermined times, dispatches a status report and remains active for a predetermined time period to the purpose of receiving a programming message that has possibly been transmitted to the device via the mobile phoning network, and
wherein the communications unit and/or the control unit are/is provided to be re-programmed by such a programming message.

3. The device according to claim 1, wherein the control unit, the clock and the communications unit are implemented in at least one, and preferably exactly one, integrated circuit.

4. The device according to claim 1, wherein the device is programmed in such a way that the control unit is alerted at predetermined times for reading out the at least one of the sensors.

5. The device according to claim 1, wherein at least one of the sensors is a resistance sensor and the device is programmed to continuously supply a required electrical voltage to said sensor.

6. The device according to claim 1, further comprising a further sensor, which is implemented as an acceleration sensor, motion sensor and/or orientation sensor.

7. The device according to claim 1, further comprising an antenna arranged to be continuously connected to the communications unit by means of a conductive connection or is embodied by the communications unit.

8. The device according to claim 1, further comprising an antenna provided to be arranged outside the distribution point, and that the device comprises means for a wireless, in particular capacitive, coupling between the antenna and the communications unit.

9. The device according to claim 1, further comprising a housing, wherein the control unit, the battery, the clock and the communications unit are arranged inside the housing, and at least one of the sensors is arranged outside the housing.

10. The device according to claim 1, wherein an address for messages dispatched by the communications unit, an alarm threshold value and/or an alert frequency for reading out the sensor respectively one of the sensors, an alert frequency for dispatching the status report and/or a time period for remaining active after dispatch of the status report are reprogrammable by the programming message.

11. A cable sleeve comprising a cable sleeve housing, feed-throughs for feeding through a plurality of optical data lines, a plurality of devices for organizing, bringing together and/or splicing optical and/or electrical data cables, as well as, in the interior of the cable sleeve housing, a device according to claim 1.

12. A duct comprising a cover made of metal or concrete as well as a cable sleeve according to claim 11.

13. A street distribution box comprising a cable sleeve according to claim 11.

14. A method for monitoring a distribution point of telecommunication lines, wherein a device according to claim 1 is provided,
wherein, on occurrence of a predetermined event detected by the sensor respectively one of the sensors, an alarm message is dispatched by the communication module, and
wherein the communications unit is alerted at predetermined times, dispatches a status report and remains active for a predetermined time period to the purpose of receiving a programming message that has possibly been transmitted to the device via the mobile phoning network.

15. The device according to claim 2, wherein the control unit, the clock and the communications unit are implemented in at least one, and preferably exactly one, integrated circuit.

16. The device according to claim 2, wherein the device is programmed in such a way that the control unit is alerted at predetermined times for reading out the at least one of the sensors.

17. The device according to claim 3, wherein the device is programmed in such a way that the control unit is alerted at predetermined times for reading out the at least one of the sensors.

18. The device according to claim 2, wherein at least one of the sensors is a resistance sensor and the device is programmed to continuously supply a required electrical voltage to said sensor.

19. The device according to claim 3, wherein at least one of the sensors is a resistance sensor and the device is programmed to continuously supply a required electrical voltage to said sensor.

20. The device according to claim 4, wherein at least one of the sensors is a resistance sensor and the device is programmed to continuously supply a required electrical voltage to said sensor.
